(19) United States
(12) Patent Application Publication
(10) Pub. No.: US 2003/0230140 A1
(43) Pub. Date: Dec. 18, 2003

(54) METHOD AND DEVICE FOR THE MEASUREMENT OF THE WINDING TENSION OF A PAPER ROLL

(76) Inventors: Peter-Christian Eccardt, Ottobrunn (DE); Hans-Georg von Garassen, Hohenkirchen (DE); Alexander von Jena, Munchen (DE); Helmut Liepold, Gremsdorf (DE)

Correspondence Address: BAKER BOTTS, LLP, 910 LOUISIANA, HOUSTON, TX, 77002-4995, US

(21) Appl. No.: 10/273,833

(22) Filed: Oct. 18, 2002

Related U.S. Application Data
(63) Continuation of application No. PCT/DE01/01490, filed on Apr. 19, 2000.

(30) Foreign Application Priority Data
Jan. 19, 2000 (DE) 10019497.4

(51) Int. Cl. G01N 21/00; G01M 7/00

(52) U.S. Cl. 73/159; 73/579

(57) ABSTRACT

Rolls of paper comprise individual layers of paper under differing degrees of tension, lying on top of each other. The aim of the invention is to measure the resulting winding tension, which varies along the radius, whereby physical interactive effects can be measured. Said aim is achieved, whereby ultrasound is irradiated in the region of the top face of the roll of paper and the resulting ultrasound recorded, after interacting with the laminated paper sheets. The interactive effects are a criterium for the winding tension. The corresponding device is an ultrasound measuring system provided with at least one ultrasound transmitter (10, 20, 30, 40, 50, 60, 70, 80, 110) and at least one ultrasound receiver (10, 20, . . . 120), which may be placed upon and moved along the top face (2) of the paper roll (1).

### CROSS REFERENCE TO RELATED APPLICATION

This application is a continuation of copending International Application No. PCT/WO01/79832 filed Oct. 25, 2001, which designates the United States.

### BACKGROUND OF THE INVENTION

The invention relates to a method for measuring the winding hardness of a paper reel by evaluating physical interaction effects between individual paper layers of the paper reel. In addition, the invention also relates to an associated device.

At the end of papermaking in the paper mill, there stands the paper reel, whose quality, critical for further processing, depends decisively on its winding hardness structure. The winding hardness structure of a reel is determined substantially by the history of the application of tension as the paper web is reeled. For example, if, in the process, outer layers on a reel are wound very firmly over relatively loose, loosely wound inner layers, the outer layers can constrict the inner ones, which leads to creases in the winding structure. When such a reel is unwound quickly on a printing machine, the paper web can then tear.

The tension history of a paper reel is often inadequate for assessing the winding hardness, since data is only inaccurate or missing or conversion operations within the reel have changed the tension relationships with respect to the state immediately after reeling. The winding hardness then has to be checked again. However, independently of this, a measurement of winding hardness in the course of final or independent quality control can also assume great importance.

From the prior art, the needle method and the strip method are known as reel-maintaining methods. In the needle method (“Smith needle”), a calibrated needle is forced between the paper layers from the end of the reel. The depth of penetration of this needle is used as a measure of the winding hardness of the reel at this point. In the strip method, strips are inserted between the paper layers during the reeling operation and are then pulled out again. The force needed for this pulling-out action is used as a measure of the winding hardness at the relevant point. Depending on the required accuracy, both methods to some extent need several hours of manual work for each winding hardness profile elaborated.

Furthermore, there are, as methods which do not maintain the reel, the stepwise cutting up of the reel (cameroon test, as it is known). In this case, a measurement is made of the extent to which the gap produced following the deliberate stepwise cutting of the paper web opens. Among all the measuring methods for the tensioned mechanical structure of the paper reel, this method exhibits the highest accuracy and the lowest dependence on semi-empirical previous knowledge.

### SUMMARY OF THE INVENTION

It is an object of the invention to specify a suitable method with which the winding hardness over an entire paper reel can be determined in a simple way, and to provide the associated device.

In the case of the method of the type mentioned at the beginning, the invention is achieved by the characterizing features of a method for measuring the winding hardness of a paper reel by evaluating physical interaction effects, ultrasound being injected along the end face of the paper reel in the radial direction by means of ultrasound transducers, and ultrasound which passes through the paper layers of the paper reel in the radial direction parallel to the end being received again, and the winding hardness being determined by measuring the changing speed of sound or attenuation of propagation of sound. An associated device is characterized by a device for measuring the winding hardness of a paper reel, said device comprising an ultrasound measuring system having at least one ultrasound transmitter and at least one ultrasound receiver, which can be placed on the end of the paper reel and displaced radially, it being possible, by means of ultrasound transmitters, for ultrasound to be injected in the radial direction along the end face of the paper reel and, by means of ultrasound receivers, for ultrasound which passes through the paper layers of the paper reel in the radial direction parallel to the end to be received. Developments of the method and of the associated device are specified in the respective dependent claims.

The invention results, in a surprisingly simple way, in a possible way of determining the winding hardness over the entire radius of a paper reel in a nondestructive manner. Prior to the invention, comprehensive theoretical investigations were made and practical trials carried out. As a result, a functioning device for practical use in paper mills was provided.

Further details and advantages of the invention emerge from the following figure description of exemplary embodiments, using the drawing in conjunction with further subclaims. In the drawing:

### BRIEF DESCRIPTION OF THE FIGURES

FIG. 1 shows the principle of determining the winding hardness of a paper reel by injecting ultrasound into the end of the reel,

FIG. 2 shows the injection of ultrasound into the end of the reel via a transducer with a wedge-like matching layer,

FIG. 3 shows a normal oscillator arrangement, in which the injection into the end of the reel is carried out via a converter deflected normal to the surface,

FIG. 4 shows two alternatives of shear oscillators at the end of the reel, with two converters deflected tangentially to the surface and parallel or at right angles to the measured section,

FIG. 5 shows two alternative implementations of shear oscillator configurations,

FIG. 6 shows alternatives for the design of injection surfaces,

FIG. 7 shows the geometry when injecting L and SV waves or SH waves,

FIG. 8 shows an array arrangement and

FIG. 9 shows a practical implementation of a measuring head for determining winding hardness with ultrasound.

### DETAILED DESCRIPTION OF THE PREFERRED EMBODIMENT OF THE INVENTION

Within the context of experimental investigations, the propagation behavior of ultrasound in a typical paper stack were investigated. The following results were obtained:

The propagation of ultrasound parallel to the paper planes takes place with low attenuation and with a high speed of sound. Neither attenuation nor speed of sound depend noticeably on the contact pressure here.

The propagation of ultrasound at right angles to the paper planes is characterized by high attenuation and low speed of sound. With increasing contact pressure, the attenuation decreases sharply and the speed of sound increases correspondingly.

In order to explain this behavior, a spring-mass model can be used.

It is known that the thickness of a paper layer is a highly nonlinear function of the effective pressure. This function or its inverse can be used to define the compressibility κ of the paper stack in the form

$$κ = {lim}_{Δ p -> 0} ( - \frac{Δ d}{Δ p} ) \frac{1}{d} \qquad ( 1 )$$

by means of the negative relative derivative of the layer thickness d with respect to the pressure p. The speed of sound C at right angles to the paper layers is then given in accordance with the equation

$$c = \sqrt{\frac{1}{ρ \cdot κ}} = \sqrt{\frac{1}{ρ \cdot {lim}_{Δ p -> 0} ( - \frac{Δ d}{Δ p} ) \frac{1}{d}}} , \qquad ( 2 )$$

where ρ is the material thickness.

For more precise observations, the differences between the isothermal and the adiabatic compressibility has to be included in the observation. In order to calculate the speed of sound, the adiabatic compressibility must always be used.

In order to register more accurately the relationship of speed of sound and sound attenuation with the pressure applied at right angles to the paper layers, measurements were carried out on a paper stack irradiated with sound at right angles to the paper layers. In the process, the pressure at right angles to the paper layers is varied by applying a contact pressure which can be adjusted via a spring balance.

The result is a rise in the speed of sound and a reduction in the attenuation with the applied pressure. Both variables follow a hysteresis curve. Here, mechanical settling processes obviously play a part, which leads to compaction and crosslinking of the paper fiber structure and take some time. Because of the settling processes mentioned, the speed of sound or sound attenuation represent anything other than an ideal measure of the pressure respectively prevailing. However, the speed of sound can be seen very directly as a measure of the current compression hardness of the paper stack. In the case of the paper reel, this corresponds to the winding hardness, which, in precise terms, depends on the pressure prevailing at right angles to the paper layers only indirectly via its time history.

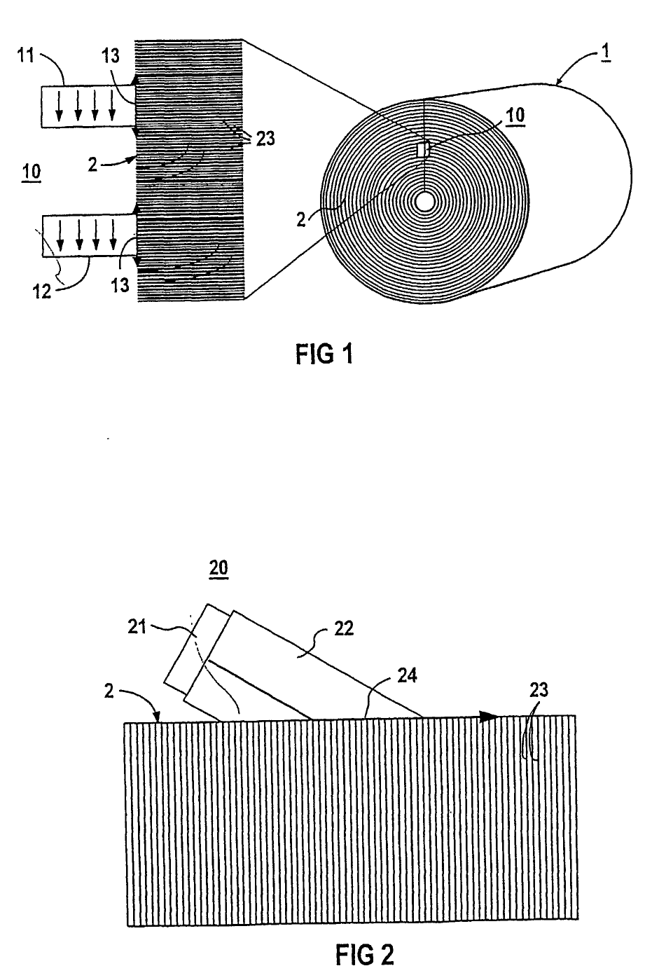

In FIG. 1, a paper reel is designated by 1. Such paper reels are present as the result of papermaking on a paper machine with subsequent winding to form parent reels, as they are known, unwinding and cutting to predefined lengths and widths, for example with a width of 1 m and a diameter of 2 m, after rewinding. Individual paper layers 23 are illustrated at the end face 2 of the reel 1. A measuring device 10 is applied to the end face 2, comprising an ultrasound transmitter 11 and an ultrasound receiver 12.

Because of the measured high signal attenuations in paper, it is not possible to radiate through more than a few centimeters (cm) of the paper coherently. For this reason, in the individual examples, the sound is injected into the end of the reel. The propagation in the paper is then measured after a few cm of propagation length, and the speed of sound in the paper, determined from this, is used as a substitute criterion for the winding hardness. In addition, the use of the signal attenuation for determining the winding hardness is conceivable. By means of displacing the measuring device radially at the end of the reel, the intention is to determine the winding hardness profile of the reel 1.

The method proposed is based on the fact that the winding hardness determined at the end of the reel 2 at a specific distance from the reel axis is also representative of the winding hardness of other stacked paper layers lying further in the interior of the reel at this axial distance. This assumption also forms the basis for the needle method mentioned at the beginning.

In detail, specific techniques result, by means of which the highest possible ultrasound amplitude is injected into the end of the reel and, after a few centimeters of travel, can be coupled out again. Here, the injection can advantageously be carried out in such a way that the highest possible proportion of the sound field is emitted at right angles to the paper layers, then moves through the paper in this direction, tangentially with respect to the surface, and can be coupled out again with a correspondingly high efficiency. Depending on transducer type and emission of the ultrasound, the following procedures may be distinguished:

1. Transducer with wedge-like injection: FIG. 2 shows a transmitting/receiving transducer 20, in which the injection of the ultrasound into the end 2 of the reel via a transducer element 21 is carried out with an adjacent wedge-like matching layer 22. The tangential injection of sound via the wedge 22 requires a wedge material which has a lower longitudinal speed of sound c_{κ} than the paper, at the speed of sound c_{P}. The angle between the transducer axis and the desired tangential emission vector must meet the condition arcsin[c_{P}/c_{κ}] in order to obtain tangential emission into the paper in accordance with arrow 24. Depending on whether the longitudinal or the transverse speed of sound in the paper is used for c_{P} in this case, waves of type L (Longitudinal waves) or SV (vertically polarized shear waves, Shear Vertical) are excited.

In the arrangement according to FIG. 2, the low requirements on the transducer 20 are advantageous. Intensive and directed waves parallel to the paper surface are produced. However, suitable materials in the range of the necessary low longitudinal speed of sound C_{κ} must be selected.

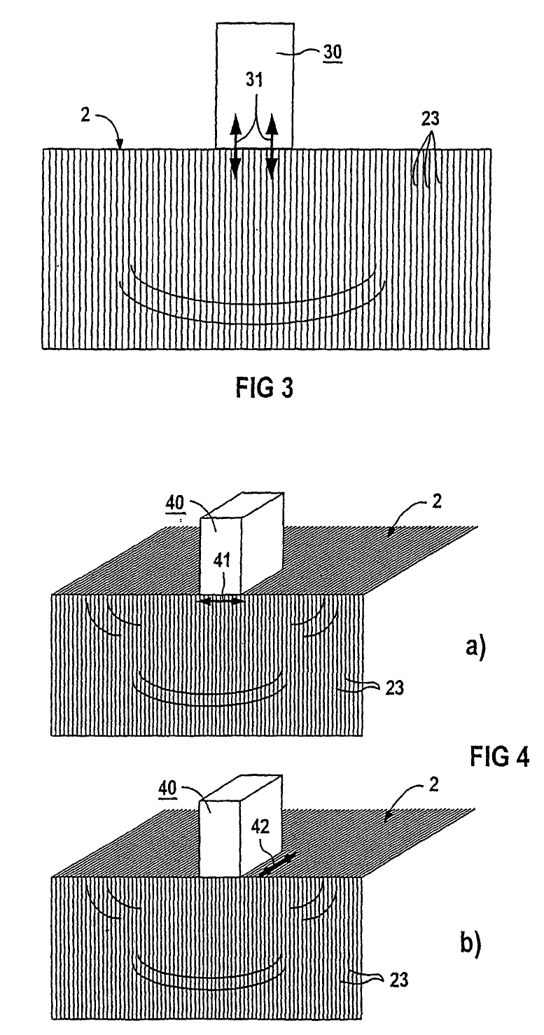

2. Normal oscillator arrangement: FIG. 3 shows an ultrasound transducer 30 with a normal oscillator arrangement and injection into the end face 2 of the reel, which is made possible by the transducer which can be deflected normally with respect to the end face, corresponding to the arrows 31. A transducer principle which is simple to implement is therefore realized. In this case, the robust coupling to the paper is advantageous, since only forces at right angles to the paper surface have to be transmitted. The sound waves emitted parallel to the paper surface comprise L-components and—by virtue of the frictional connection of the paper webs—of SV components, but overall have only a relatively low intensity.

3. Shear oscillator arrangements for polarization directions oriented at right angles to each other: FIG. 4 shows an ultrasound transducer 40 with ultrasound emission via shear oscillators into the end 23 of the reel. In this case, two different examples result with two transducers deflected tangentially with respect to the surface but at right angles to each other in both cases, corresponding to the arrows 41 and 42. In part 4a of the figure, the transducer 40 oscillates with its effective edge 41 on the right and left, at right angles to the paper layers 23, and in part 4b of the figure, with the edge to the front and rear, parallel to the paper layers 23. The acoustic waves are received on the right or left of the transducer 40.

In both cases, the transducer 40 primarily transmits shear deflections and forces tangentially to the surface of the paper, in the directions of arrows 41 and 42. This requires a more complex transducer construction. In this case, since shear forces have to be transmitted, the coupling to the paper is far more sensitive. This means, that for reliable force transmission, greater pressing forces are required, with the risk that the paper surface will be damaged.

As illustrated in detail in FIG. 4, two mutually perpendicular orientations of the shear oscillators are conceivable. Arrangement (a) emits L and SV waves, also as superimpositions in the form of surface waves, arrangement (b) emits SH waves (horizontally polarized shear waves, Shear Horizontal) in the direction of the receiver to be fitted on the right or left of the transmitting transducer 40. The advantage as compared with the normal oscillator resides in any case in the more intense emission tangential with respect to the surface and at right angles to the paper layers. According to experimental investigations, in this case arrangement (a) has the higher signal, arrangement (b), on the other hand, less interfering signals and less superimposition of different wave types. It should be noted that arrangement (b) is not able to transmit any signal via the air, for reasons of symmetry, since there are no transverse waves in air.

For the implementation of shear oscillators 40 with oscillation directions 41 and 42 on the basis of bulk piezoelectric material, there are substantially two possibilities, as illustrated in FIG. 5. FIG. 5 reveals, in parts a) and b), two different implementation forms 50 and 60 for shear oscillator configurations, illustrated by using the shear wave polarization corresponding to the arrows 53 and 63 shown in FIG. 5.

FIG. 5a illustrates a bimorph arrangement, as it is known: two wafers 51 and 52 with inverted linear expansion and compression direction are joined side by side, in a way analogous to a bimetallic strip. In this case, either both materials, for example of piezoelectric ceramic, can be active as an electromechanical transducer and polarized and driven in opposite directions (bimorph), or else, for example, as an electromechanically active piezoelectric ceramic, connected by a force fit to an inactive material, for example metal or plastic (monomorph). In FIG. 5b, polarization and applied electric field are not parallel. This results in excitation of internal shear even in homogeneous material.

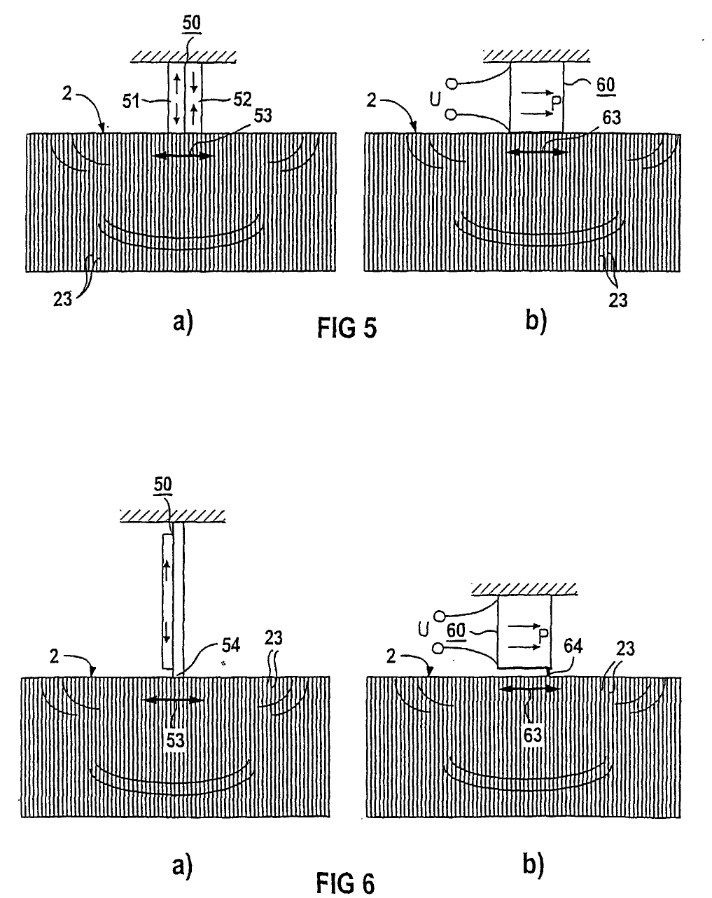

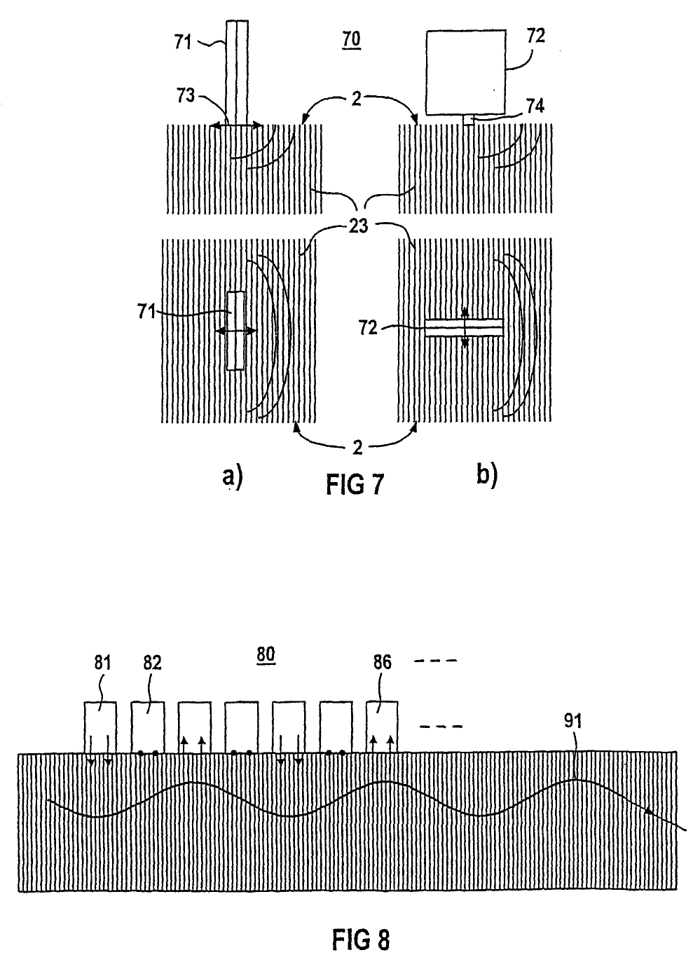

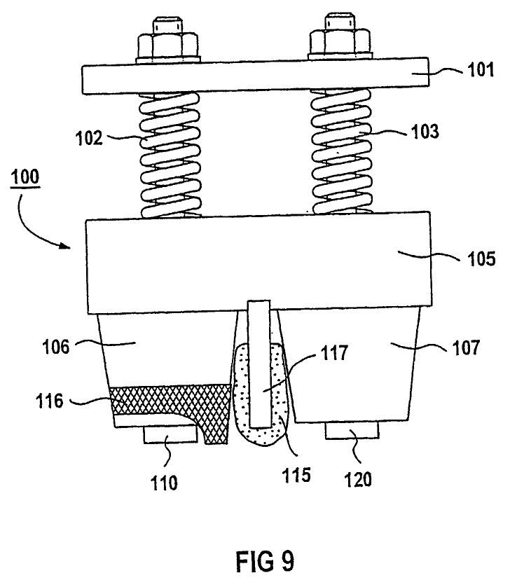

4. Amplification of the emission parallel to the paper surface by lateral modulation of the effective transducer deflection: the shear oscillators described above exhibit a maximum of the acoustic emission in the depth direction of the paper. This is based essentially on the fact that, in the tangential direction of the surface, those contributions of different parts of the transducer surface whose path length difference in the paper along the surface reaches the magnitude λ/2 cancel one another out. Here, λ represents the wavelength of the acoustic signal propagating in the tangential direction in the paper. A relatively simple way of reducing this canceling effect is the use of sharp edges for the transducers. For example, the right-hand edge of the shear oscillator shown in FIG. 5 can be tilted downward somewhat, so that it presses more intensely into the paper than the left-hand edge. This is also implemented in particular in the measuring head according to FIG. 9, which will be described in detail further below. However, other suitable geometries for this purpose can also be conceived. One example is the use of two closely adjacent bounding edges, which is illustrated in detail in FIG. 6 and FIG. 7.

The effect of the respective injection area of the ultrasound will be clarified by using FIG. 6. The result in FIG. 6a) is an ultrasound transducer 50 as a monomorph from FIG. 5a but, by comparison, with a narrower injection face 54. In FIG. 6b), the ultrasound transducer 60 is constructed as a transverse oscillator according to FIG. 5b) with a reduced injection face 64. In both cases, an improvement in the emission of sound and injection into the paper reel is achieved.

The individual wave types which are produced by an ultrasound transducer 70 will be illustrated by using FIG. 7. FIG. 7a shows an ultrasound transducer 20 for injecting L and SV waves through a flexural oscillator 70 with parallel, and FIG. 7b shows the ultrasound transducer 70 for injecting SH waves in the direction of arrow 73 through a flexural oscillator 72 via its bottom face as an injection face. In this case, the transducer 71 oscillates in the direction of the measured section and the transducer 72 with injection face 76 at right angles to the measured section on the end face 23 of the paper reel.

The advantage of this type of spatial modulation of the transducer deflection consists in the simplicity of application. The effectiveness, which is only limited in some cases, can be increased considerably by an array arrangement in all the transducer types illustrated, but at the price of a considerably higher mechanical and circuit-based expenditure. The principle of the array arrangement emerges from the illustration according to FIG. 8.

FIG. 8 shows an array 80 of individual ultrasound transducers 81, 82, . . . 86. The specific excitation of a surface wave 90 will be illustrated by using the array 80 having the normal oscillators 81, 82, . . . The array principle functions just as well with shear oscillators. If a large number of transducers is arranged radially over the end face of a paper reel, in each case two adjacent transducers 81 and 82 and 83 and 84, etc., can be used as transmitter and receiver for the respectively singular local measurement of the winding hardness at one radial point on the end face of the reel. However, groups of transducers can also be driven with a phase offset, so that the result is a wavefront whose course can be controlled. For example, one transducer group 81, 83, 85, . . . is connected as a transmitter and one transducer group 82, 84, 86,. . . as a receiver.

In this case, the phase difference between the respectively activated transducers must be matched to the transducer spacing and the speed of sound in the paper. In the case of phase-offset driving, the phase offset is advantageously set so as to be proportional to the spatial coordinate along the measured section of the paper reel. A proportionality factor is chosen in such a way that the transmission of the ultrasound in the direction of the measured section is maximized.

For practical measurements, an arrangement of two shear oscillators placed slightly canted on the paper is suitable. A measuring head 100 in this regard is reproduced in FIG. 9. The measuring head 100 is used to measure the speed of sound at the end 2 of the paper reel and, for this purpose, has two ultrasound transducers 110 and 120 preferably constructed as shear transducers. Arranged between the two transducers 110 and 120 serving as transmitter or receiver are shielding means 115 and 117 against acoustic and electric crosstalk.

The significant parameters of the device according to FIG. 9 were investigated in detail in a measuring arrangement according to FIG. 1, a suitable course of the signal occurring at the receiver transducer resulting as a measure of the winding hardness of a paper reel. The first zero crossing after the acoustic signal has arrived at the receiver is evaluated.

The mechanical construction of the measuring head 100 contains, in detail, of a clamping device 101, by means of which a PVC block 105 is held by compression springs 102 and 103. Fitted to the PVC block 105, electrically insulated by rubber layers 106 and 107, are a first shear transducer 110 and a second shear transducer 120, of which one serves as an ultrasound transmitter and the other as an ultrasound receiver. Between the two transducers there is the shielding means 115 already mentioned in order to eliminate airborne sound. For the purpose of electrical shielding, use is made of a copper network 116 and the metallic body 117.

The measuring head described in this way is placed on the end face 2 of the paper reel 1, as illustrated by way of example in FIG. 1, a suitable radial position for each measurement being predefined manually. The shielding means prevent electric and acoustic crosstalk during the measurement. As mentioned, the shear transducers are canted slightly with respect to each other in order to maintain the transmitting and receiving conditions, for which purpose there may be compensating layers present.

The measuring head 100 according to FIG. 9 can also be introduced into a suitable carriage as a displacement device, so that it can be displaced radially on the end face 2 of the paper reel 1. The measuring head 100 was constructed as a prototype and used successfully for measurements on paper reels.

The characteristic parameters result from the experimental investigations. By using the measuring head 100, a signal waveform was determined from which the winding hardness of a paper reel can be determined reproducibly. Therefore, a valuable aid for practical use in paper mills has been provided.

What is claimed is:

1. A method for measuring the winding hardness of a paper reel by evaluating physical interaction effects, ultrasound being injected along the end face of the paper reel in the radial direction by means of ultrasound transducers, and ultrasound which passes through the paper layers of the paper reel in the radial direction parallel to the end being received again, and the winding hardness being determined by measuring the changing speed of sound or attenuation of propagation of sound.

2. The method as claimed in claim 1 wherein the sound is coupled in and out at right angles to the surface on the end face of the paper reel by means of the ultrasound transducer set into oscillation, substantially a measurement of the propagation speed or of the propagation attenuation of longitudinal waves or transverse (SV) and surface waves being carried out.

3. The method as claimed in claim 1 wherein the sound is coupled in and out at right angles to the direction of the paper layers by a frictional connection between the ultrasound transducer and the end face of the paper reel, substantially a measurement of the propagation speed and propagation attenuation of longitudinal waves and transverse (SV) and surface waves being carried out.

4. The method as claimed in claim 1 wherein the sound is coupled in and out in the direction of the paper layers by frictional connection between the ultrasound transducer and the end face of the paper reel, substantially a measurement of the propagation speed and propagation attenuation of transverse (SH) waves being carried out.

5. The method as claimed in claim 1 wherein the sound is injected via a wedge whose speed of sound is less than the speed of sound to be measured in the paper.

6. The method as claimed in claim 1 wherein the injection is carried out via transverse oscillators.

7. The method as claimed in claim 1 wherein the injection is carried out via flexural oscillators (FIG. 5a, FIG. 6a, FIG. 7).

8. A device for measuring the winding hardness of a paper reel, said device comprising an ultrasound measuring system having at least one ultrasound transmitter and at least one ultrasound receiver, which can be placed on the end of the paper reel and displaced radially, it being possible, by means of ultrasound transmitters, for ultrasound to be injected in the radial direction along the end face of the paper reel and, by means of ultrasound receivers, for ultrasound which passes through the paper layers of the paper reel in the radial direction parallel to the end to be received.

9. The device as claimed in claim 8 wherein the measuring system comprising an ultrasound transmitter and ultrasound receiver forms a measuring head with ultrasound transducers which are sonically decoupled.

10. The device as claimed in claim 8 wherein the ultrasound transducers are constructed as transverse oscillators.

11. The device as claimed in claim 8 wherein the ultrasound transducers are constructed as flexural oscillators.

12. The device as claimed in claim 8 wherein an ultrasound measuring system is formed by a transmitting/receiving array of individual ultrasound transducers.

13. The device as claimed in claim 12 wherein the individual ultrasound transducers of the array are driven with a phase offset.

14. The device as claimed in claim 13 wherein the phase offset is selected to be proportional to the spatial coordinate along the measured section, to be specific with a proportionality factor such that the transmission in the direction of the measured section is maximized.

15. The device of claim 12 wherein the array of ultrasound transducers is arranged radially on the end face of the paper reel and for the purpose of measurement in each case an adjacent pair of ultrasound transducers is switched as a separate transmitter and receiver to measure radially different winding hardnesses of the paper reel.

16. The device of claim 12 wherein the array of ultrasound transducers is arranged radially on the end face of the paper reel, and for the purpose of measurement an adjacent group of transducers is in each case connected as a transmitting array driven with a phase offset, and an adjacent group of transducers is connected as a receiving array driven with a phase offset.

17. The device of claim 9 further comprising a second device for the displacement of the ultrasound measuring head radially with respect to the end of the paper reel.

18. The device of claim 17 wherein the two ultrasound transducers of the measuring head are arranged tilted with respect to one another, retained by the second displacement device, and pressed against the end of the paper reel.
